(19) United States
(12) Patent Application Publication
(10) Pub. No.: US 2018/0160424 A1
(43) Pub. Date: Jun. 7, 2018

(54) METHODS TO ENABLE TIME SENSITIVE APPLICATIONS IN SECONDARY CHANNELS IN A MMWAVE IEEE 802.11 WLAN

(71) Applicant: INTEL CORPORATION, SANTA CLARA, CA (US)

(72) Inventors: Dave CAVALCANTI, Beaverton, OR (US); Carlos CORDEIRO, Portland, OR (US); Roya DOOSTNEJAD, Los Altos, CA (US)

(21) Appl. No.: 15/366,827

(22) Filed: Dec. 1, 2016

(51) Int. Cl. H04W 72/04; H04W 48/10; H04B 7/04; H04W 72/08

(52) U.S. Cl. CPC H04W 72/0446; H04W 48/10; H04W 88/08; H04W 72/082; H04B 7/0408

(57) ABSTRACT

Time Sensitive Networks (TSN) are networks that provide time synchronization and timeliness (deterministic latency and reliability/redundancy) guarantees to important or critical data flows. Traditionally, TSN applications have used wired connectivity (e.g., Ethernet TSN) for reliability. However, wiring has several limitations such as high maintenance cost, weight and limited mobility. Moreover, many TSN applications (e.g., Automotive and Industrial control) could benefit from enabling TSN-grade (wired) performance over a wireless network, i.e., a wireless TSN (WTSN) as discussed herein.

### TECHNICAL FIELD

An exemplary aspect is directed toward communications systems. More specifically an exemplary aspect is directed toward wireless communications systems and even more specifically to IEEE (Institute of Electrical and Electronics Engineers) 802.11 wireless communications systems. Even more specifically, exemplary aspects are at least directed toward one or more of IEEE (Institute of Electrical and Electronics Engineers) 802.11ac/ax/ay communications systems, 60 GHz communications systems, mmWave communications systems, IEEE 802.11TGay communications, MU-MIMO communications systems and in general any wireless communications system or protocol, including WiGig, 4G, 4G LTE, 5G and later, and the like. Additional aspects have further applicability to Internet of Things (IoT) devices and wireless time sensitive networks.

### BACKGROUND

Wireless networks transmit and receive information utilizing varying techniques and protocols. For example, but not by way of limitation, two common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax/ay standards.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

IEEE 802.11ay is a type of WLAN. IEEE 802.11ay is proposed to have a frequency of 60 GHz, a transmission rate of 20-40 Gbit/s and an extended transmission distance of 300-500 meters. IEEE 802.11ay is also proposed to include an architecture for channel bonding and MU-MIMO. IEEE 802.11ay is not intended to be a new type of WLAN, but rather an improvement to IEEE 802.11ad.

Millimeter wave (mmWave) wireless technology generally corresponds to the portion of the radio spectrum between 30 GHz to 300 GHz, with corresponding wavelengths between one and ten millimeters. For wireless communications, mmWave currently corresponds to bands of spectrum near 38 GHz, 60GHx and 94 GHz, and in particular to bands between 70 GHz and 90GH.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary WTSN environment;

FIG. 2 illustrates an exemplary beacon interval and data transmission interval;

FIG. 3 illustrates an exemplary access point/station/device; and

FIG. 4 illustrates an exemplary bit allocation according to one embodiment;

FIG. 5 illustrates an exemplary an exemplary extension to one or more service periods; and

FIG. 6 is a is a flowchart illustrating an exemplary method for beam refinement in scheduled SPs for TSN STAs in a secondary channel.

### DESCRIPTION OF EMBODIMENTS

The IEEE 802.11ay task group provides recommendations for the evolving IEEE 802.11 standard for the mmWave (60 GHz) band. IEEE 802.11ay may use Down Link MU-MIMO (Multi-User Multi-Input Multi-Output) as one of the methods to achieve enhanced throughput through concurrent transmission to multiple devices. Multi-user MIMO (MU-MIMO) is a set of multiple-input and multiple-output technologies for wireless communication, in which a set of wireless devices, each with one or more antennas (which can be multiple element antennas and/or phased arrays), communicate with each other. In contrast, single-user MIMO considers a single multi-antenna transmitter communicating with a single multi-antenna receiver. MU-MIMO is sometimes referred to as space-division multiple access (SDMA); users that are transmitting at the same time and frequency may be separated using their different spatial signatures. In a similar way that OFDMA adds multiple access (multi-user) capabilities to OFDM, MU-MIMO adds multiple access (multi-user) capabilities to MIMO.

In Down Link MU-MIMO, an AP transmits to several STAs/devices concurrently. In the mmWave band, directional transmissions are used so it is necessary for both the AP and the STAs to set their antenna arrays (by setting their antenna weight vectors—AWVs) in the best way to receive the transmissions directed to them by the AP and to avoid interference from transmissions directed to other devices.

Time Sensitive Networks (TSN) are networks that provide time synchronization and timeliness (deterministic latency and reliability/redundancy) guarantees to important or critical data flows. Traditionally, TSN applications have used wired connectivity (e.g., Ethernet TSN) for reliability. However, wiring has several limitations such as high maintenance cost, weight and limited mobility. Moreover, many TSN applications (e.g., Automotive and Industrial control) could benefit from enabling TSN-grade (wired) performance over a wireless network, i.e., a wireless TSN (WTSN).

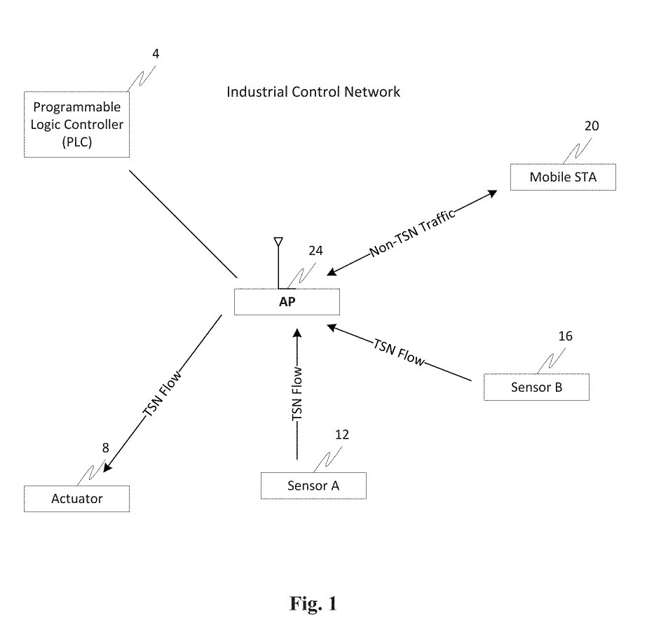

TSN applications include a mix of traffic patterns and requirements, but synchronous TSN data flows (e.g., between sensors, actuators and controllers in a closed loop control system) can be the most critical. Some TSN flows require latencies on the order of 10's of μs with high or very high reliability. An exemplary WTSN scenario is illustrated in FIG. 1. More specifically, FIG. 1 illustrates an exemplary industrial control network with a WTSN. Here, the industrial control network includes one or more programmable logic controllers 4, one or more actuators 8, one or more sensors 12, 16, one or more mobile stations 20 and an access point (AP) 24. Within the network there are various TSN flows as well as non-TSN traffic. Each TSN flow in this exemplary scenario can generate a synchronous data stream with a fixed packet size and inter-arrival period.

Given the available bandwidth, Wi-Fi/IEEE 802.11 connectivity in mmWave bands (e.g. 60 GHz) is a potential candidate to support TSN applications with ultra-low latency requirements (e.g., 10's of μs). Operation in the unlicensed spectrum can allow for very low deployment costs, while on the other hand, the unlicensed spectrum also imposes challenges, especially to guarantee reliabilities comparable to wired protocols (e.g., Ethernet TSN).

The IEEE 802.11ad standard includes a reservation-based MAC layer mode which enables dedicated Service Periods (SPs) to be assigned to TSN traffic. However, depending on how often beamforming training is required, the training overhead could impose some limitations in supporting synchronous TSN flows with short inter-arrival periods.

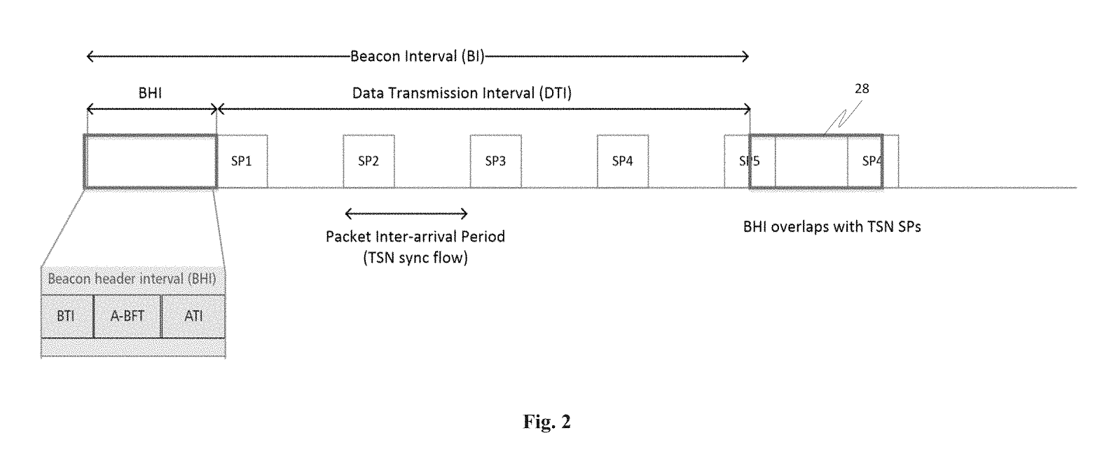

Consider the scenario in FIG. 1 where there are several synchronous TSN flows. Regular IEEE 802.11ad Service Periods (SPs) (SP1, SP2, SP3, SP4, SP5 . . . ) can be reserved for a TSN flow as shown in FIG. 2. However, as shown in the FIG. 2, depending on the packet inter-arrival period for the TSN flow, and duration of the periodic Beacon Header Interval (BHI), there is a possibility of overlap 28 between TSN frames and the BHI.

Even the smallest possible BHI, which would include only the BTI phase (a number of DMG beacon transmissions using the IEEE 802.11ad Control PHY), could last for hundreds of μs, depending on the number of beacons. This would require TSN STAs to buffer their packets and miss their delivery deadlines, which is determined by the control cycle latency.

One way to address this is to allow an AP to assign specific channels for TSN applications/STAs in order to prevent interference from non-TSN STAs. This can be complemented with operations across primary and secondary channels. The complement assumes that the BTI (Beacon Time Interval), A-BFT (An access period during which beamforming training is performed with the STA that transmitted a DMG Beacon frame during the preceding BTI. The presence of the A-BFT is optional and signaled in DMG Beacon frames) and ATI (A request-response based management access period between the AP or PCP and non-AP and non-PCP STAs. The presence of the ATI is optional and signaled in DMG Beacon frames) always occur on the primary channel of the BSS (Basic Service Set).

Therefore, even if a secondary channel is reserved for TSN flows, the TSN STAs may still have to return to the primary channel to perform required control/management frame exchanges with the AP, which could interfere with the transmissions/receptions of synchronous TSN frames in the secondary channel, especially when the control cycle latency requirement is very low, e.g., in the order of 10's of μs.

An exemplary embodiment enables the AP and TSN STAs to perform the required control/management frame exchanges (e.g., beamforming training) without interfering with scheduled SPs for TSN synchronous flows.

The successful reception of synchronization beacons and announce frames are required for STAs in order to maintain association and synchronization, which are also required to guarantee latency and high reliability expected by TSN applications. Therefore, it is critical to coordinate both types of transmissions to avoid overlaps such as those shown in FIG. 2.

One exemplary embodiment schedules synchronous TSN flows in a secondary channel and defines new methods for APs and STAs to coordinate the required control/management frame exchange to maintain synchronization and beamforming training without interfering with TSN flows.

In accordance with one exemplary embodiment some assumptions are made.

First, it is assumed that the TSN capable network operates in a managed environment and there are no unmanaged nearby Wi-Fi networks. (Note that this is a reasonable assumption for most industrial and enterprise environments where the TSN application could be used.)

Second, it is assumed that a STA with critical TSN flows (referred hereafter as TSN STA) will request access with certain QoS requirements (e.g., defined in for example a TSPEC) that characterizes the TSN requirements. The AP would, therefore, be aware of TSN traffic streams.

Third, it is assumed that the AP may be equipped with multiple radios to enable simultaneous communications in at least two channels. This is also a reasonable assumption for industrial control networks, which are optimized for performance, low latency and high reliability.

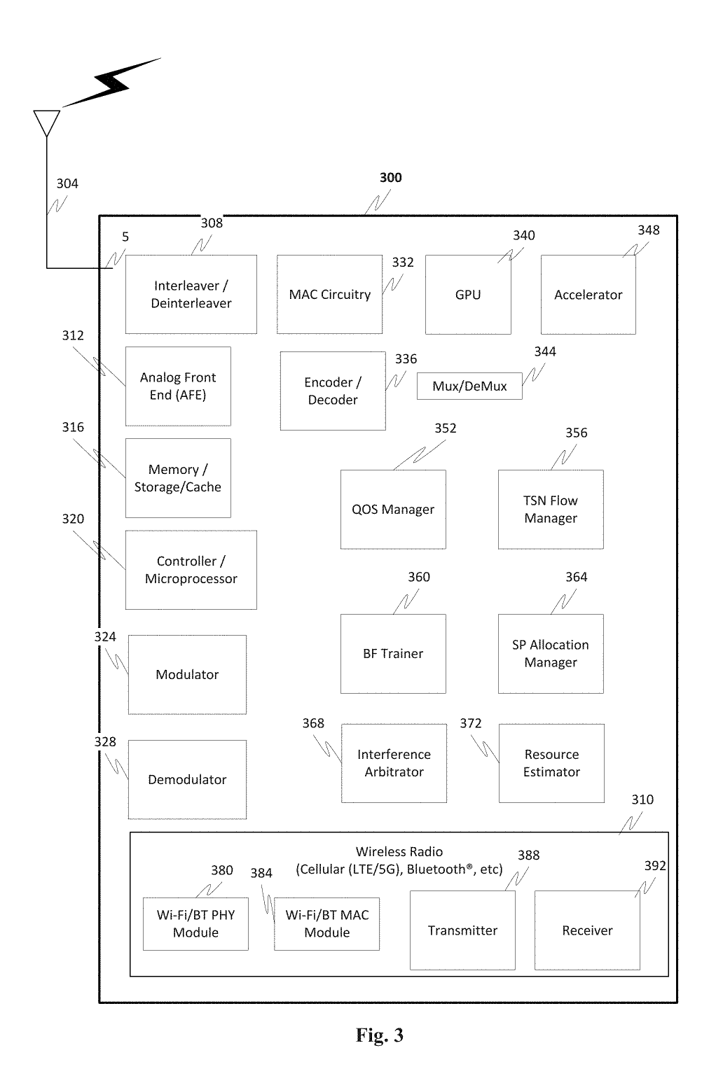

FIG. 3 illustrates an exemplary hardware/functional block diagram of a device 300, such as a wireless device, IoT device, mobile device, access point (AP), station (STA), or in general any device, that is adapted to implement the technique(s) discussed herein.

In addition to well-known componentry (which has been omitted for clarity), the device 300 includes interconnected elements including one or more of: one or more antennas 304 and associated antenna ports, an interleaver/deinterleaver 308, an analog front end (AFE) 312, memory/storage/cache 316, controller/microprocessor 320, MAC circuitry 332, modulator 324, demodulator 328, encoder/decoder 336, GPU 340, accelerator 348, a multiplexer/demultiplexer 344, a QOS manager 352, a TSN flow manager 356, a BF (beamforming) trainer 360, an SP allocation manager 364, an interference arbitrator 368, a resource estimator 372 and wireless radio 310 components such as a Wi-Fi PHY module/circuit 380, a Wi-Fi/BT MAC module/circuit 384, transmitter 388 and receiver 392. The various elements in the device 300 are connected by one or more links/connections 5 (with not all shown, again for sake of clarity).

The device 300 can have one more antennas 304, for use in wireless communications such as Wi-Fi, multi-input multi-output (MIMO) communications, multi-user multi-input multi-output (MU-MIMO) communications, Bluetooth®, LTE, 5G, 60 Ghz, WiGig, mmWave systems, etc. The antenna(s) 304 can include, but are not limited to one or more of directional antennas, omnidirectional antennas, monopoles, patch antennas, loop antennas, microstrip antennas, dipoles, and any other antenna(s) suitable for communication transmission/reception. In one exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users/devices.

Antenna(s) 304 generally interact with the Analog Front End (AFE) 312, which is needed to enable the correct processing of the received modulated signal and signal conditioning for a transmitted signal. The AFE 312 can be functionally located between the antenna and a digital baseband system in order to convert the analog signal into a digital signal for processing, and vice-versa.

The device 300 can also include a controller/microprocessor 320 in communication with a memory/storage/cache 316. The device 300 can interact with the memory/storage/cache 316 which may store information and operations necessary for configuring and transmitting or receiving the information and performing one or more portions of the techniques described herein. The memory/storage/cache 316 may also be used in connection with the execution of application programming or instructions by the controller/microprocessor 320, and for temporary or long term storage of program instructions and/or data. As examples, the memory/storage/cache 320 may comprise a computer-readable device, RAM, ROM, DRAM, SDRAM, and/or other storage device(s) and media.

The controller/microprocessor 320 may comprise a general purpose programmable processor or controller for executing application programming or instructions related to the device 300. Furthermore, the controller/microprocessor 320 can cooperate with one or more other elements in the device 300 to perform operations for configuring and transmitting information and performing operations as described herein. The controller/microprocessor 320 may include multiple processor cores, and/or implement multiple virtual processors. Optionally, the controller/microprocessor 320 may include multiple physical processors. By way of example, the controller/microprocessor 320 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 300 can further include a transmitter 388 and receiver 392 which can transmit and receive signals, respectively, to and from other wireless devices and/or access points using the one or more antennas 304. Included in the device 300 circuitry is the medium access control or MAC Circuitry 332. MAC circuitry 332 provides for controlling access to the wireless medium. In an exemplary embodiment, the MAC circuitry 332 may be arranged to contend for the wireless medium and configure frames or packets for communicating over the wireless medium.

The device 300 can also optionally contain a security module (not shown). This security module can contain information regarding but not limited to, security parameters required to connect the device to an access point or other device, or vice versa, or other available network(s), and can include WEP or WPA/WPA-2 (optionally+AES and/or TKIP) security access keys, network keys, etc. As an example, the WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

As shown in FIG. 3, the exemplary device 300 can also include a GPU 340, an accelerator 348, multiplexer/demultiplexer 344, a Wi-Fi/BT/BLE PHY module 380 and a Wi-Fi/BT/BLE MAC module 384 that at least cooperate with one or more of the other components as discussed herein.

Exemplary association procedure and admission control for TSN STAs

In cooperation with the TSN flow manager 356 and BF trainer 360, TSN STAs can follow the usual network entry and beamforming training procedures to associate with an AP. Once associated with an AP (or PCP (Control Point)), the TSN STAs sends by the transmitter 388 an admission control request (ADDTS Request frame) to the AP with the DMG TSPEC (directional multi-gigabit (DMG) traffic specification (TSPEC)) to create a new allocation for its TSN flow. The DMG TSPEC describes, for example, the QoS required (as managed by the QOS manager 352), including the maximum frame size, frame inter-arrival period and delay bound per frame.

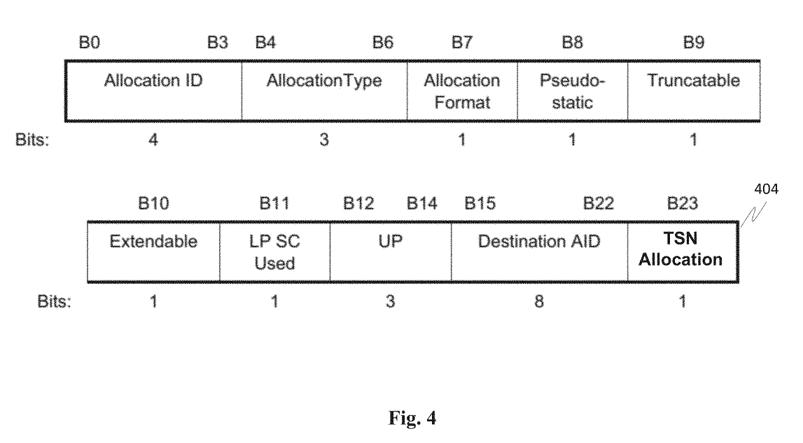

In one embodiment, a reserved bit (B23) in the DMG Allocation Info field can be used to indicate that the TSPEC request is for a TSN flow (see FIGS. 4-404). When set to 1, this field can allow the AP to identify whether the AP needs to start a TSN specific beamforming training and admission control procedure as described herein.

Exemplary beam refinement in scheduled SPs for TSN STAs in secondary channel

Once the AP identifies a TSN STA's request, the AP, with the SP allocation manager 364, provides an allocation of Service Periods (SPs) to the TSN STA in a target secondary channel (TSN dedicated channel) to perform the beam refinement protocol (BRP). The channel information can be added to the schedule element as discussed above. The AP, with the interference arbitrator 368, can then ensure that the scheduled SPs for BRP do not interfere with other allocations in the TSN dedicated channel. The scheduled SPs may not meet the TSN flow's TSPEC as requested by the TSN STA, as they are scheduled for BRP only.

Once the BRP is completed by the BF trainer 360, the AP, with the resource estimator 372, estimates the required resources (e.g., SP durations) for supporting the TSN flow. The AP may consider a combination of parameters, such as supported MCS, reliability requirements, latency and traffic load in the TSN dedicated channel, etc. If the AP decides to admit the new flow, the AP can send a ADDTS Response frame and schedule a new allocation of SPs with the SP allocation manager 364 to serve the TSN flow.

Maintaining synchronization for TSN STAs with active TSN flows in a secondary channel

After receiving the ADDTS Response and the new SP allocation, the TSN STA can start using the scheduled SPs for TSN data frame transmissions in the TSN dedicated channel. In order to maintain association, synchronization, and resource allocation with the AP, the TSN STA needs to receive DMG Beacons or Announce frames.

In one exemplary embodiment, the SP allocation manager 364 in the AP provides a scheduled allocation of SPs only for transmitting synchronization beacons or announce frames, which does not overlap/interfere with the TSN flow allocation.

This SP could be scheduled with broadcast destination AID (association identity), such that all TSN STAs on that channel receive the same synchronization frame. The period between SPs may be aligned with the minimal time required to maintain synchronization (e.g., beacon interval). Note that the timing of the SP allocations to maintain synchronization in the TSN channel may not coincide with the BHI period in the primary channel.

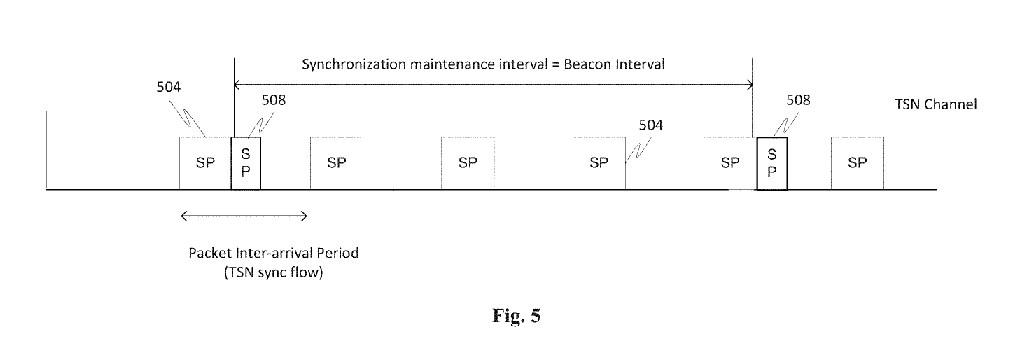

In accordance with yet another exemplary embodiment illustrated in FIG. 5, the AP may, with the cooperation of the SP allocation manager 364, reserve extra time 508 during the scheduled SPs 504 for the TSN flow to enable an additional transmission of a Beacon or Announce frame. The AP may use this option depending, for example, on latency requirements and the load on the TSN channel. Although this option may add overhead to each SP, since synchronization information may not need to be exchanged as frequently as TSN frames, the extra time in the SP may also be used as redundancy, for instance to enable a retransmission. Any system with beamforming training will need to search for direction of base station which requires overhead. One exemplary advantage of this option is that this option can remove the long duration of BHI from the dedicated channel.

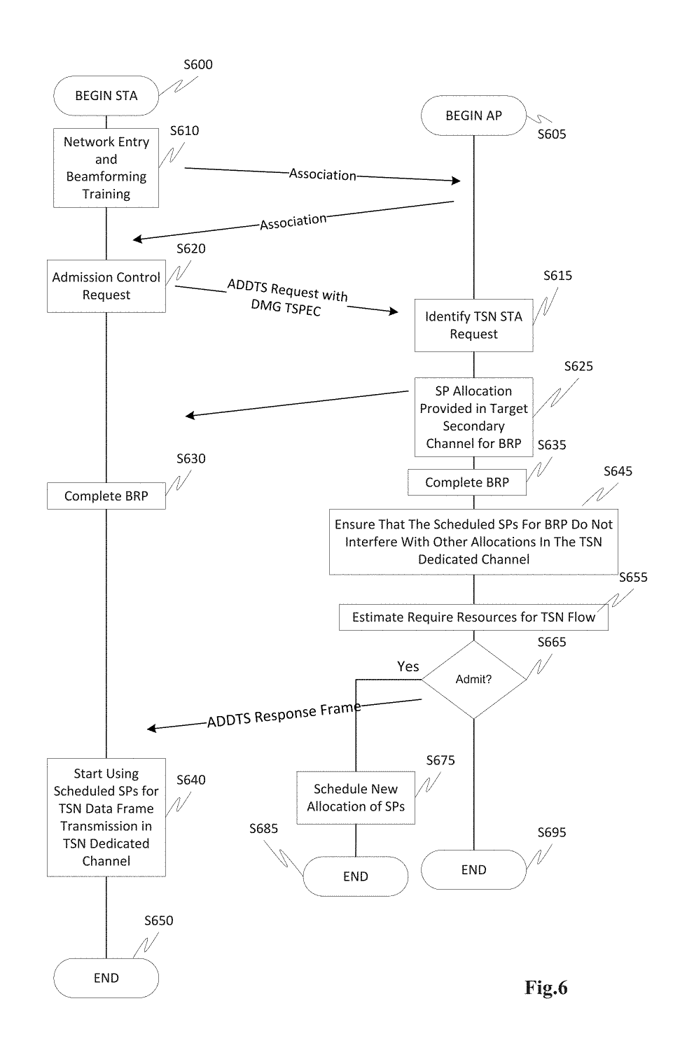

FIG. 6 outlines an exemplary method for enabling time sensitive applications in secondary channel(s). In particular control begins in step S600 and continues to step S610.

In step S610, TSN STAs follow the usual network entry and beamforming training procedures to associate with an AP. Once associated with an AP (or PCP (Control Point)), in step S620, the TSN STAs sends an admission control request (ADDTS Request frame) to the AP with the DMG TSPEC to create a new allocation for the STAs TSN flow. As discussed, the DMG TSPEC describes, for example, the QoS required (as managed by the QOS manager 352), including the maximum frame size, frame inter-arrival period and delay bound per frame.

In step S615, the AP identifies a TSN STA's request and in step S625 provides an allocation of Service Periods (SPs) to the TSN STA in a target secondary channel (TSN dedicated channel) to perform the beam refinement protocol (BRP) (Steps S630 and S635). The channel information can be added to the schedule element as discussed above. The AP, in step S645, can then ensure that the scheduled SPs for BRP do not interfere with other allocations in the TSN dedicated channel.

Once the BRP is completed, the AP, in step S655, estimates the required resources (e.g., SP durations) for supporting the TSN flow. The AP may consider a combination of parameters, such as supported MCS, reliability requirements, latency and traffic load in the TSN dedicated channel, etc. If the AP decides to admit the new flow in step S665, the AP can send a ADDTS Response frame and schedule, in step S675, a new allocation of SPs to serve the TSN flow. Control then continues to step S685 where the control sequence ends.

In step S640, and after receiving the ADDTS Response and the new SP allocation, the TSN STA can start using the scheduled SPs for TSN data frame transmissions in the TSN dedicated channel. In order to maintain association, synchronization, and resource allocation with the AP, the TSN STA needs to receive DMG Beacons or Announce frames as discussed. Control then continues to step S650 where the control sequence ends.

While the exemplary embodiments have been described in relation to specific IEEE 802.11 protocols, it should be appreciated that the techniques disclosed herein can be extended beyond the Wi-Fi environment using, for example, another frame structure. Additionally, it should be appreciated that in general a second channel could be used for control/management.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless communications device comprising:

a controller and connected receiver that receive an admission control request from a time sensitive network station and identify the request;

a service period allocation manager that allocates service periods to the time sensitive network station in a secondary channel;

a beamforming trainer that performs a beam refinement protocol; and

a resource estimator and processor that estimate required resources for supporting a time sensitive network flow.

Any of the above aspects, wherein the processor and an interference arbitrator arbitrate the allocated service periods and other time sensitive network allocations.
Any of the above aspects, further comprising a time sensitive network flow manager that cooperates with the beamforming trainer to perform network entry and beamforming training procedures.
Any of the above aspects, wherein the controller and a transmitter further send an ADDTS (Add Traffic Stream) response frame for an admitted time sensitive network flow.
Any of the above aspects, wherein the device receives data frame transmissions using the allocated service periods.
Any of the above aspects, wherein the device and the time sensitive network station exchange one or more DMG (Directional Multi-Gigabit) beacons and Announce Frames.
Any of the above aspects, wherein extra time is reserved for one or more of the service periods and/or a service period is scheduled with broadcast destination AID (association identity) such that all time sensitive network stations on a channel receive a same synchronization frame.
Any of the above aspects, further comprising one or more connected elements including an interleaver/deinterleaver, an analog front end, a GPU, an accelerator, an encoder/decoder, one or more antennas and memory.
A non-transitory information storage media having stored thereon one or more instructions, that when executed by one or more processors, cause a wireless communications device to perform a method comprising:

receiving an admission control request from a time sensitive network station and identifying the request;

allocating service periods to the time sensitive network station in a secondary channel;

performing a beam refinement protocol; and

estimating required resources for supporting a time sensitive network flow.

Any of the above aspects, wherein the processor and an interference arbitrator arbitrate the allocated service periods and other time sensitive network allocations.
Any of the above aspects, further comprising performing network entry and beamforming training procedures.
Any of the above aspects, further comprising sending an ADDTS (Add Traffic Stream) response frame for an admitted time sensitive network flow.
Any of the above aspects, wherein the device receives data frame transmissions using the allocated service periods.
Any of the above aspects, wherein the device and the time sensitive network station exchange one or more DMG (Directional Multi-Gigabit) beacons and Announce Frames.
Any of the above aspects, wherein extra time is reserved for one or more of the service periods and/or a service period is scheduled with broadcast destination AID (association identity) such that all time sensitive network stations on a channel receive a same synchronization frame.
A wireless communications device, the device comprising: memory and processor circuitry configured to:

receive an admission control request from a time sensitive network station and identifying the request;

allocate service periods to the time sensitive network station in a secondary channel;

perform a beam refinement protocol; and

estimate required resources for supporting a time sensitive network flow.

Any of the above aspects, wherein the processor and an interference arbitrator arbitrate the allocated service periods and other time sensitive network allocations.
Any of the above aspects, further comprising a time sensitive network flow manager that cooperates with the beamforming trainer to perform network entry and beamforming training procedures.
Any of the above aspects, wherein the processor and a transmitter further send an ADDTS (Add Traffic Stream) response frame for an admitted time sensitive network flow.
Any of the above aspects, wherein extra time is reserved for one or more of the service periods.
A wireless communications device, the device comprising:
means for receiving an admission control request from a time sensitive network station and identifying the request;
means for allocating service periods to the time sensitive network station in a secondary channel;
means for performing a beam refinement protocol; and
means for estimating required resources for supporting a time sensitive network flow.

Any of the above aspects, further comprising means for arbitrating the allocated service periods and other time sensitive network allocations.

Any of the above aspects, further comprising means for performing network entry and beamforming training procedures.

Any of the above aspects, further comprising means for sending an ADDTS (Add Traffic Stream) response frame for an admitted time sensitive network flow.

Any of the above aspects, wherein extra time is reserved for one or more of the service periods and/or a service period is scheduled with broadcast destination AID (association identity) such that all time sensitive network stations on a channel receive a same synchronization frame.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhancing and improving communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a controller and connected receiver that receive an admission control request from a time sensitive network station and identify the request;
a service period allocation manager that allocates service periods to the time sensitive network station in a secondary channel;
a beamforming trainer that performs a beam refinement protocol; and
a resource estimator and processor that estimate required resources for supporting a time sensitive network flow.

2. The wireless communications device of claim 1, wherein the processor and an interference arbitrator arbitrate the allocated service periods and other time sensitive network allocations.

3. The wireless communications device of claim 1, further comprising a time sensitive network flow manager that cooperates with the beamforming trainer to perform network entry and beamforming training procedures.

4. The wireless communications device of claim 1, wherein the controller and a transmitter further send an ADDTS (Add Traffic Stream) response frame for an admitted time sensitive network flow.

5. The wireless communications device of claim 1, wherein the device receives data frame transmissions using the allocated service periods.

6. The wireless communications device of claim 1, wherein the device and the time sensitive network station exchange one or more DMG (Directional Multi-Gigabit) beacons and Announce Frames.

7. The wireless communications device of claim 1, wherein extra time is reserved for one or more of the service periods and/or a service period is scheduled with broadcast destination AID (association identity) such that all time sensitive network stations on a channel receive a same synchronization frame.

8. The wireless communications device of claim 1, further comprising one or more connected elements including an interleaver/deinterleaver, an analog front end, a GPU, an accelerator, an encoder/decoder, one or more antennas and memory.

9. A non-transitory information storage media having stored thereon one or more instructions, that when executed by one or more processors, cause a wireless communications device to perform a method comprising:
receiving an admission control request from a time sensitive network station and identifying the request;
allocating service periods to the time sensitive network station in a secondary channel;
performing a beam refinement protocol; and
estimating required resources for supporting a time sensitive network flow.

10. The media of claim 9, wherein the processor and an interference arbitrator arbitrate the allocated service periods and other time sensitive network allocations.

11. The media of claim 9, further comprising performing network entry and beamforming training procedures.

12. The media of claim 9, further comprising sending an ADDTS (Add Traffic Stream) response frame for an admitted time sensitive network flow.

13. The media of claim 9, wherein the device receives data frame transmissions using the allocated service periods.

14. The media of claim 9, wherein the device and the time sensitive network station exchange one or more DMG (Directional Multi-Gigabit) beacons and Announce Frames.

15. The media of claim 9, wherein extra time is reserved for one or more of the service periods and/or a service period is scheduled with broadcast destination AID (association identity) such that all time sensitive network stations on a channel receive a same synchronization frame.

16. A wireless communications device, the device comprising: memory and processor circuitry configured to:
receive an admission control request from a time sensitive network station and identifying the request;
allocate service periods to the time sensitive network station in a secondary channel;
perform a beam refinement protocol; and
estimate required resources for supporting a time sensitive network flow.

17. The device of claim 16, wherein the processor and an interference arbitrator arbitrate the allocated service periods and other time sensitive network allocations.

18. The device of claim 16, further comprising a time sensitive network flow manager that cooperates with the beamforming trainer to perform network entry and beamforming training procedures.

19. The device of claim 16, wherein the processor and a transmitter further send an ADDTS (Add Traffic Stream) response frame for an admitted time sensitive network flow.

20. The device of claim 16, wherein extra time is reserved for one or more of the service periods.
